(19) United States
(12) Patent Application Publication
(10) Pub. No.: US 2016/0042022 A1
(43) Pub. Date: Feb. 11, 2016

(54) DATA COORDINATION SUPPORT APPARATUS AND DATA COORDINATION SUPPORT METHOD

(71) Applicant: MITSUBISHI ELECTRIC CORPORATION, Tokyo (JP)

(72) Inventor: Akihiro SATO, Tokyo (JP)

(73) Assignee: MITSUBISHI ELECTRIC CORPORATION, Tokyo (JP)

(21) Appl. No.: 14/783,384

(22) PCT Filed: May 30, 2013
(86) PCT No.: PCT/JP2013/065026

§ 371 Date: Oct. 8, 2015

(51) Int. Cl. G06F 17/30

(52) U.S. Cl. CPC G06F 17/30336; G06F 17/30345

(57) ABSTRACT

A data coordination support apparatus is provided to efficiently detect between which table and a table being a coordination destination there is a reference relation, in data coordination. The data coordination support apparatus identifies, with respect to each table other than the table being the coordination destination, a first column designated as the primary key and a second column not designated as the primary key, from a plurality of columns included in a table concerned. The data coordination support apparatus extracts such a table that a third column similar to the first column is included in the table being the coordination destination, and a fourth column similar to the second column is included the table being the coordination destination, from tables other than the table being the coordination destination. The data coordination support apparatus outputs recommendation information that recommends using a combination of the table being the coordination destination and the table extracted, in the data coordination.

### TECHNICAL FIELD

The present invention relates to a data coordination apparatus and data coordination support method.

### BACKGROUND ART

Data coordination between databases on different systems, or data coordination between different tables in the same database is required in association with coordination between systems, or integration of systems. In data coordination, it is necessary to define a data coordination relation of from a column of which table (i.e., a coordination source table) should data to be contained in a column of a table (i.e., a coordination destination table) being a coordination destination be extracted.

It is necessary to detect a corresponding relation of columns between tables in some way to define the data coordination relation. Furthermore, it is necessary to be able to create a table layout, which is a combination of columns of the coordination destination table, from the coordination source table by a table operation. If such conversion of data structure cannot be carried out, data cannot be contained in the coordination destination table. In a case where there is no coordination source table the layout of which matches the coordination destination table, and the coordination destination table is to be created by gathering data from two or more coordination source tables, it is insufficient to determine the corresponding relation only by similarity of columns between tables. It is necessary to actually be able to carry out a joining (e.g., JOIN) operation on the two or more coordination source tables.

As described above, in the data coordination, it is necessary to generate a coordination destination table by joining (e.g., JOIN) the coordination source tables. Therefore, it is necessary to identify a reference relation between tables in advance to define the data coordination relation. In a general database, however, there are many cases where a primary key constraint is imposed, but a foreign referential constraint is not imposed and thus the reference relation between tables is not clear. Therefore, conventionally, the reference relation between the tables is extracted manually. This work needs to be done by an advanced engineer who has understanding of database technology and of business contents in a labor-intensive way.

As an art for automatically extracting the reference relation between the tables, there is an art that uses records (i.e., actual data) of tables of a database (for example, refer to Non-Patent Literature 1).

As an art for automatically extracting the corresponding relation between similar columns, there is the so-called schema matching technique (for example, refer to Non-Patent Literature 2).

### CITATION LIST

### Non-Patent Literature

[Non-Patent Literature 1] Ling Ling Yan, Renee J. Miller, Laura M. Haas, and Ronald Fagin, “Data-Driven Understanding and Refinement of Schema Mappings”, SIGMOD '01 Proceedings of the 2001 ACM SIGMOD international conference on Management of data, 2001

[Non-Patent Literature 2] Ronald Fagin, Laura M. Haas, Mauricio Hernandez, Renee J. Miller, Lucian Popa, and Yannis Velegrakis, “Clio: Schema Mapping Creation and Data Exchange”, Lecture Notes in Computer Science Volume 5600, 2009

### SUMMARY OF INVENTION

### Technical Problem

In Non-Patent Literature 1, records of tables of a database are read, relationship between the records and a joining relation between the tables are inferred, and thereby the reference relation between the tables is extracted automatically. To improve extraction accuracy of the reference relation, it is necessary to use all of the records. In such a case, a process for a large quantity of records is necessary. In a case where such a process is executed for a large scale system, there is a high possibility that processing time extends beyond practical time. Systems for which the process is to be executed must inevitably be narrowed down.

A sampling technique can be utilized in order to decrease the number of records to be used. It, however, is difficult to perform sampling while keeping the reference relation between the tables in consideration. There is a possibility that, as a result of the sampling, tables that essentially have the reference relation are found as having no reference relation.

As described above, with the art that requires use of records as in Non-Patent Literature 1, there is a problem that a range of systems to which the art can be applied is restricted depending on the quantity of the records.

With the schema matching technique as described in Non-Patent Literature 2, a corresponding relation between similar columns can be extracted only from meta data such as table definition information. Therefore, by comparison with the art that uses records, there is an advantage that the handled amount of data is small. The process can be executed for the entirety of a large scale system.

The schema matching technique, however, is a technique to find similar columns. Therefore, the technique cannot be used as it is to automatically extract the reference relation between tables. Especially, in a case where a large number of columns of the same meaning exist in a database, many corresponding relations that are not reference relations, while being correct corresponding relations from a perspective of the schema matching technique, are detected.

Further, in the schema matching technique, there is a problem that necessity of creating a layout of a coordination destination table from a coordination source table to perform data coordination by a table operation is not put into consideration.

The present invention aims, for example, to efficiently detect between which table and a table being a coordination destination there is a reference relation, in data coordination.

### Solution to Problem

A data coordination support apparatus according to one aspect of the present invention is an apparatus that supports data coordination of a database including a plurality of tables. The data coordination support apparatus includes:

an information storage unit to store primary key information indicating whether or not each of a plurality of columns included in each of the plurality of tables is designated as a primary key, and attribute information indicating an attribute of data contained in each of the plurality of columns included in each of the plurality of tables;

a table selection unit to select a table being a coordination destination of the data coordination, from among the plurality of tables;

a column identification unit to identify, with respect to each table among the plurality of tables other than the table selected by the table selection unit, a first column designated as the primary key and a second column not designated as the primary key, from a plurality of columns included in a table concerned, based on the primary key information stored in the information storage unit;

a table extraction unit to extract such a table that a third column similar to the first column identified by the column identification unit is included in the table selected by the table selection unit, and a fourth column similar to the second column identified by the column identification unit is included in the table selected by the table selection unit, from tables among the plurality of tables other than the table selected by the table selection unit, based on the attribute information stored in the information storage unit; and

an information output unit to output recommendation information that recommends using a combination of the table selected by the table selection unit and the table extracted by the table extraction unit, in the data coordination.

### Advantageous Effects of Invention

According to one aspect of the present invention, the data coordination support apparatus is able to efficiently detect between which table and a table being a coordination destination there is a reference relation in data coordination.

### BRIEF DESCRIPTION OF DRAWINGS

FIG. 1 a block diagram illustrating a configuration of a data coordination support apparatus according to a first embodiment;

FIG. 2 a table illustrating an example of coordination source information according to the first embodiment;

FIG. 3 a flowchart illustrating an example of behavior of the data coordination support apparatus according to the first embodiment;

FIG. 4 a table illustrating an example of reference source information and primary key definition information according to the first embodiment;

FIG. 5 a table illustrating an example of a result of schema matching according to the first embodiment;

FIG. 6 a table illustrating an example of reference relation information according to the first embodiment;

FIG. 7 a flowchart illustrating an example of behavior of the data coordination support apparatus according to the first embodiment;

FIG. 8 a table illustrating an example of non-foreign key definition information and non-primary key definition information according to the first embodiment;

FIG. 9 a table illustrating an example of a result of schema matching according to the first embodiment;

FIG. 10 a table illustrating an example of coordination relation information according to the first embodiment;

FIG. 11 a flowchart illustrating an example of behavior of the data coordination support apparatus according to the first embodiment;

FIG. 12 a table illustrating an example of an extraction result according to the first embodiment;

FIG. 13 a flowchart illustrating an example of behavior of the data coordination support apparatus according to the first embodiment;

FIG. 14 a table illustrating an example of input information and recommendation information according to the first embodiment; and

FIG. 15 a diagram illustrating an example of a hardware configuration of the data coordination support apparatus according to the first embodiment.

### DESCRIPTION OF EMBODIMENTS

In the following, an embodiment of the present invention will be explained in reference to the drawings.

### Embodiment 1

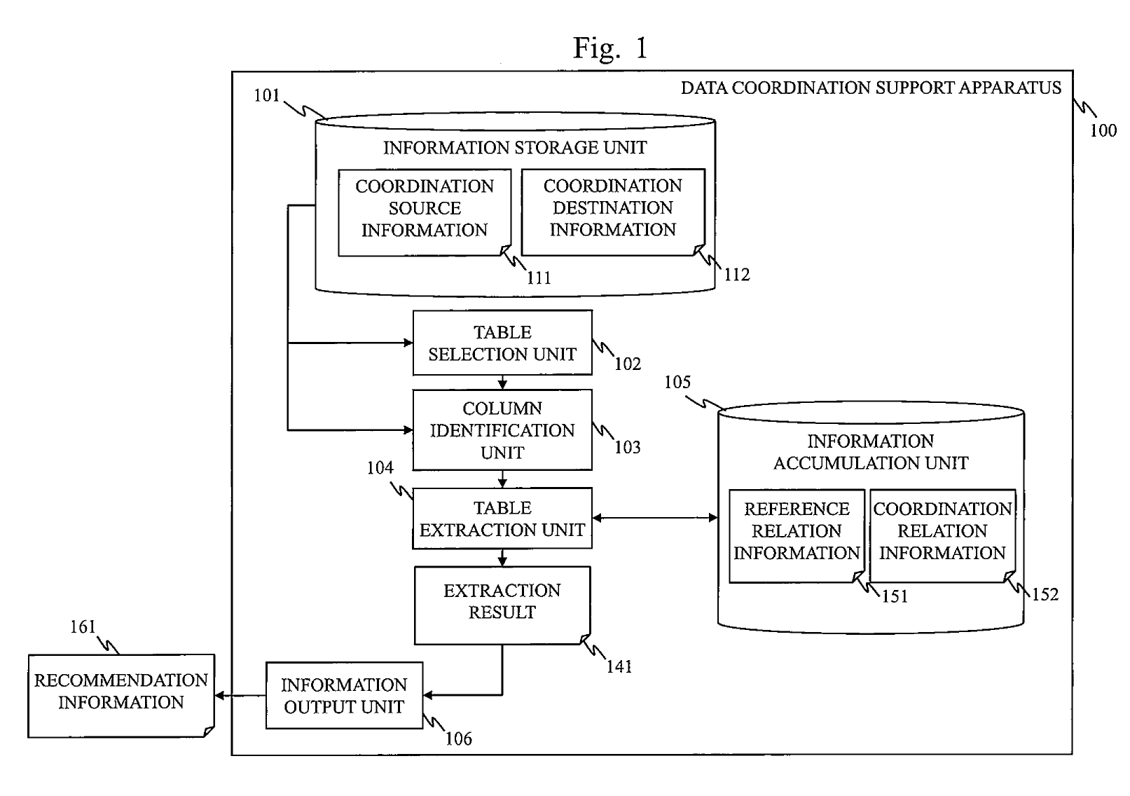

FIG. 1 is a block diagram illustrating a configuration of a data coordination support apparatus 100 according to the present embodiment.

In FIG. 1, the data coordination support apparatus 100 is an apparatus that supports data coordination of a database including a plurality of tables. The data coordination supported by the data coordination support apparatus 100 may be data coordination between different instances of the database, data coordination between different schemas of the same instance, or data coordination between different tables of the same schema.

The data coordination support apparatus 100 includes an information storage unit 101, a table selection unit 102, a column identification unit 103, a table extraction unit 104, an information accumulation unit 105, and an information output unit 106.

Although not illustrated in FIG. 1, the data coordination support apparatus 100 includes hardware such as a processing device, a storage device, an input device, and an output device. The hardware is used by each unit of the data coordination support apparatus 100. For example, the processing device is used for performing computation, processing, reading, writing, and so on of data or information in each unit of the data coordination support apparatus 100. The storage device is used for storing the data or the information. The input device is used for inputting the data or the information. The output device is used for outputting the data or the information.

The information storage unit 101 stores coordination source information 111 and coordination destination information 112 by using the storage device.

The coordination source information 111 is information that defines a plurality of tables (i.e., coordination source tables) of a database (i.e., a coordination source database) being a coordination source of the data coordination. Primary key information and attribute information of the coordination source database are included in the coordination source information 111. The primary key information of the coordination source database is information indicating whether or not each of a plurality of columns included in each of the plurality of coordination source tables is designated as the primary key. The attribute information of the coordination source database is information indicating an attribute of data (e.g., a column name and a data type) contained in each of the plurality of columns included in each of the plurality of coordination source tables.

The coordination destination information 112 is information that defines a plurality of tables (i.e., coordination destination tables) of a database (i.e., a coordination destination database) being a coordination destination of the data coordination. Primary key information and attribute information of the coordination destination database are included in the coordination destination information 112. The primary key information of the coordination destination database is information indicating whether or not each of a plurality of columns included in each of the plurality of coordination destination tables is designated as the primary key. The attribute information of the coordination destination database is information indicating an attribute of data (e.g., a column name and a data type) contained in each of the plurality of columns included in each of the plurality of coordination destination tables.

The coordination source information 111 and the coordination destination information 112 are inputted via the input device, and stored in the information storage unit 101.

The table selection unit 102 selects a coordination destination table from among the plurality of coordination destination tables.

For example, the table selection unit 102 reads the coordination destination information 112 stored in the information storage unit 101. The table selection unit 102 selects a coordination destination table from the coordination destination tables defined by the coordination destination information 112 that has been read.

The column identification unit 103 identifies, with respect to each table among the plurality of tables of the coordination source database and the coordination destination database other than the coordination destination table selected by the table selection unit 102, a first column designated as the primary key and a second column not designated as the primary key, from a plurality of columns included in a table concerned, based on the primary key information described above.

For example, the column identification unit 103 reads the coordination source information 111 and the coordination destination information 112 stored in the information storage unit 101. The column identification unit 103 identifies, with respect to each of the coordination source tables defined by the coordination source information 111 that has been read, a first column and a second column, based on the primary key information included in the coordination source information 111 that has been read. The column identification unit 103 identifies, with respect to each of the coordination destination tables among the coordination destination tables defined by the coordination destination information 112 that has been read other than the coordination destination table selected by the table selection unit 102, a first column and a second column, based on the primary key information included in the coordination destination information 112 that has been read.

The table extraction unit 104, with respect to each table among the plurality of tables of the coordination source database and the coordination destination database other than the coordination destination table selected by the table selection unit 102, extracts a table that satisfies the following conditions (1) and (2) based on the attribute information described above, and outputs an extraction result 141.
(1) A third column similar to the first column identified by the column identification unit 103 is included in the coordination destination table selected by the table selection unit 102.
(2) A fourth column similar to the second column identified by the column identification unit 103 is included the coordination destination table selected by the table selection unit 102.

In the present embodiment, the table extraction unit 104, with respect to a table in which two or more first columns are identified by the column identification unit 103, extracts such a table that the third column exists, in the coordination destination table selected by the table selection unit 102, individually for all of the first columns. For example, suppose that two first columns exist in a coordination source table. If a third column similar to one of the two first columns, and another third column similar to the other of the two first columns exist in the coordination destination table selected by the table selection unit 102, it can be concluded that the coordination source table satisfies the above condition (1). It is possible that not only a coordination source table, but also a coordination destination table different from the coordination destination table selected by the table selection unit 102 satisfies the above condition (1).

In the present embodiment, the table extraction unit 104, with respect to a table in which two or more second columns are identified by the column identification unit 103, includes in the extraction result 141, only such a table that the fourth column exists, in the coordination destination table selected by the table selection unit 102, individually for the largest number of the second columns. For example, suppose that five second columns exist in a coordination source table. Suppose that a fourth column similar to one of the five second columns, and another fourth column similar to the other of the five second columns exist in the coordination destination table selected by the table selection unit 102. If not more than two fourth columns exist with respect to the other coordination source tables, and not more than two fourth columns exist with respect to coordination destination tables other than the coordination destination table selected by the table selection unit 102, it can be concluded that the coordination source table satisfies the above condition (2). It is possible that not only a coordination source table, but also a coordination destination table different from the coordination destination table selected by the table selection unit 102 satisfies the above condition (2).

In the present embodiment, the table extraction unit 104 may include in the extraction result 141, three types of tables: a table that belongs to the same schema as the coordination destination table selected by the table selection unit 102, a table that belongs to a different schema of the same instance as the coordination destination table selected by the table selection unit 102, and a table that belongs to a schema of a different instance than the coordination destination table selected by the table selection unit 102.

The information accumulation unit 105 stores reference relation information 151 and coordination relation information 152 by using the storage device.

The reference relation information 151 is information indicating a pair of columns that results in a reference relation between the coordination destination table selected by the table selection unit 102 and the table extracted by the table extraction unit 104. The reference relation information 151 is, namely, information indicating a pair of the first column and the third column.

The coordination relation information 152 is information indicating a pair of corresponding columns other than the columns that result in the reference relation between the coordination destination table selected by the table selection unit 102 and the table extracted by the table extraction unit 104. The reference relation information 151 is, namely, information indicating a pair of the second column and the fourth column.

The reference relation information 151 and the coordination relation information 152 are created by the table extraction unit 104 and stored in the information accumulation unit 105. The reference relation information 151 and the coordination relation information 152 may be outputted by the table extraction unit 104 as a final extraction result 141, or may be saved temporarily in the information accumulation unit 105 and used for deciding on the final extraction result 141.

The information output unit 106 generates recommendation information 161 that recommends using a combination of the coordination destination table selected by the table selection unit 102 and the table extracted by the table extraction unit 104, in the data coordination, based on the extraction result 141 outputted from the table extraction unit 104. The information output unit 106 outputs the recommendation information 161 generated, via the output device.

In a case where at least two types of tables out of the three types of tables described above are included in the extraction result 141 outputted from the table extraction unit 104, the information output unit 106 outputs, as the recommendation information 161, information that recommends using the combination of the coordination destination table selected by the table selection unit 102 and the table extracted by the table extraction unit 104, in the data coordination, for each table type.

The output device may be a display device that displays the recommendation information 161 on a screen or may be a computer that executes some sort of a process by using the recommendation information 161.

Hereinafter, an example of behavior (i.e., a data coordination support method according to the present embodiment) of the data coordination support apparatus 100 will be described.

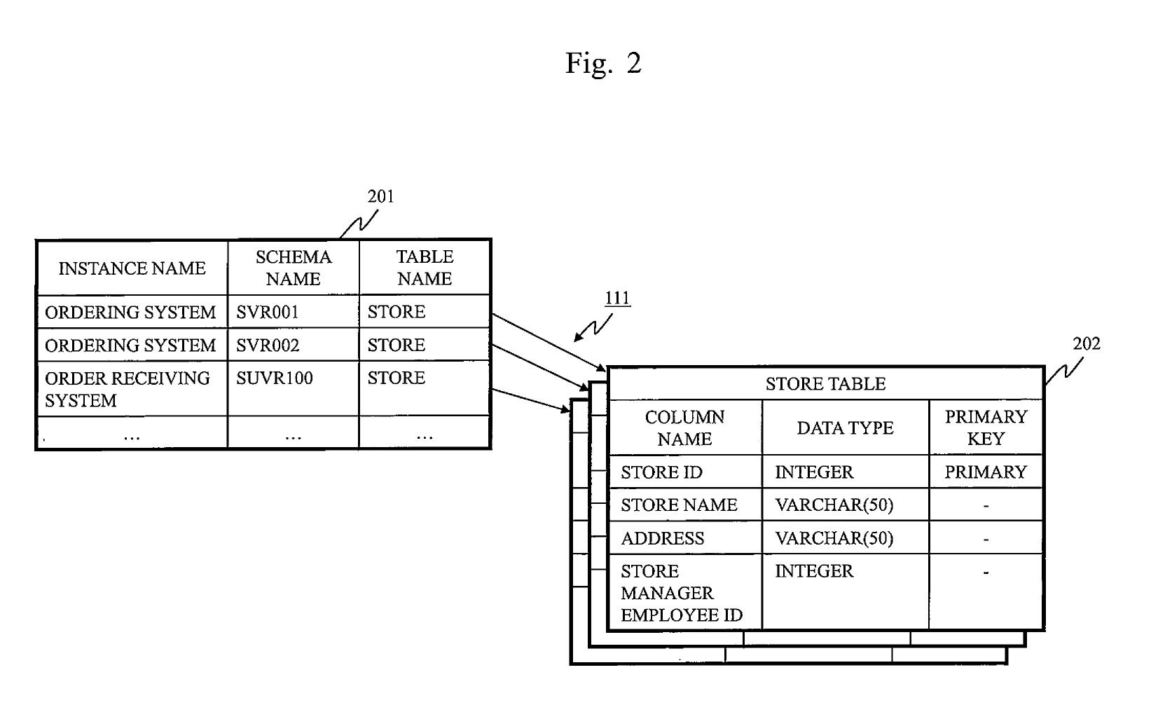

FIG. 2 is a table illustrating an example of the coordination source information 111.

In FIG. 2, the coordination source information 111 is information that defines the coordination source tables, as described above. The coordination source information 111 is stored in the information storage unit 101 in advance, as a file written in DDL (Data Definition Language) or in XML (eXtensible Markup Language). Alternatively, the coordination source information 111 is obtained from the coordination source database by issuing an SQL statement and so on, and stored in the information storage unit 101. Table location information 201 and table definition information 202 are included in the coordination source information 111.

Information of an instance name, a schema name, and a table name is included in the table location information 201. For example, it is defined in the table location information 201 that a “Store” table is in a schema “SVR001” of an instance “Ordering System”.

The table definition information 202 is stored for each coordination source table defined in the table location information 201. Information (i.e., the attribute information and the primary key information) of a column name, a data type, and the primary key is included in the table definition information 202. For example, in the table definition information 202 of the “Store” table in the “SVR001” of the “Ordering System”, it is defined that the “Store” table includes columns “Store ID”, “Store Name”, “Address”, and “Store Manager Employee ID”, and the “Store ID” alone is designated as the primary key.

Although not illustrated in the drawings, the coordination destination information 112 is also information in the same format as the coordination source information 111 illustrated in FIG. 2.

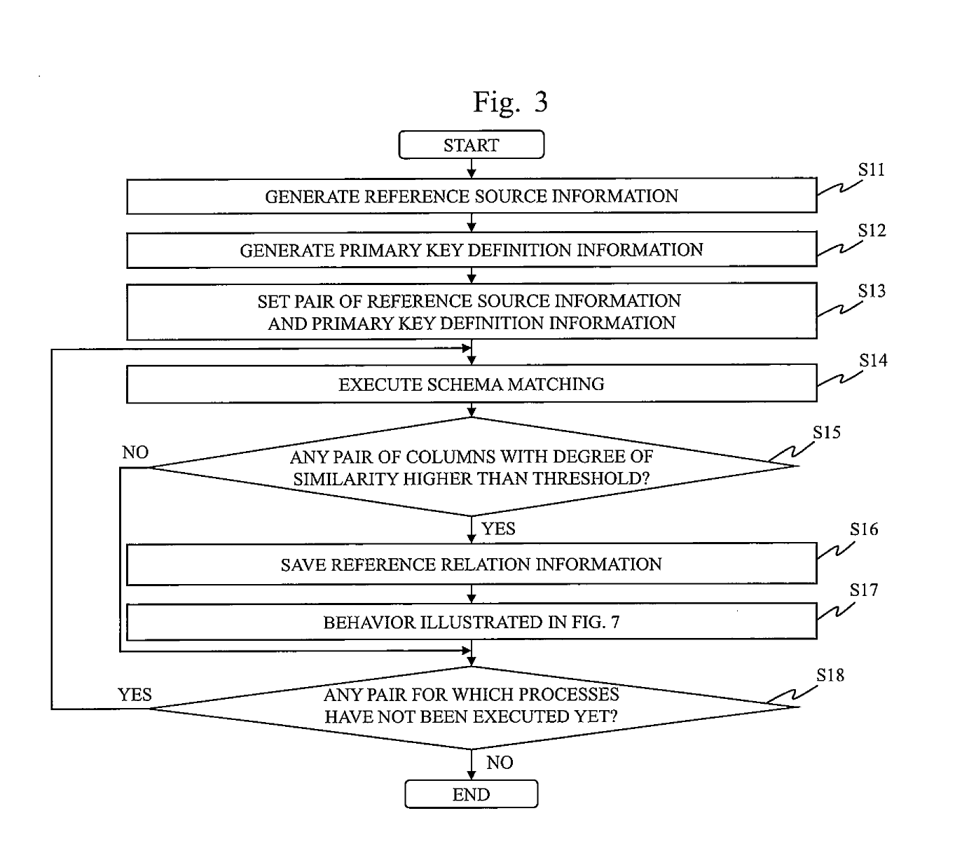

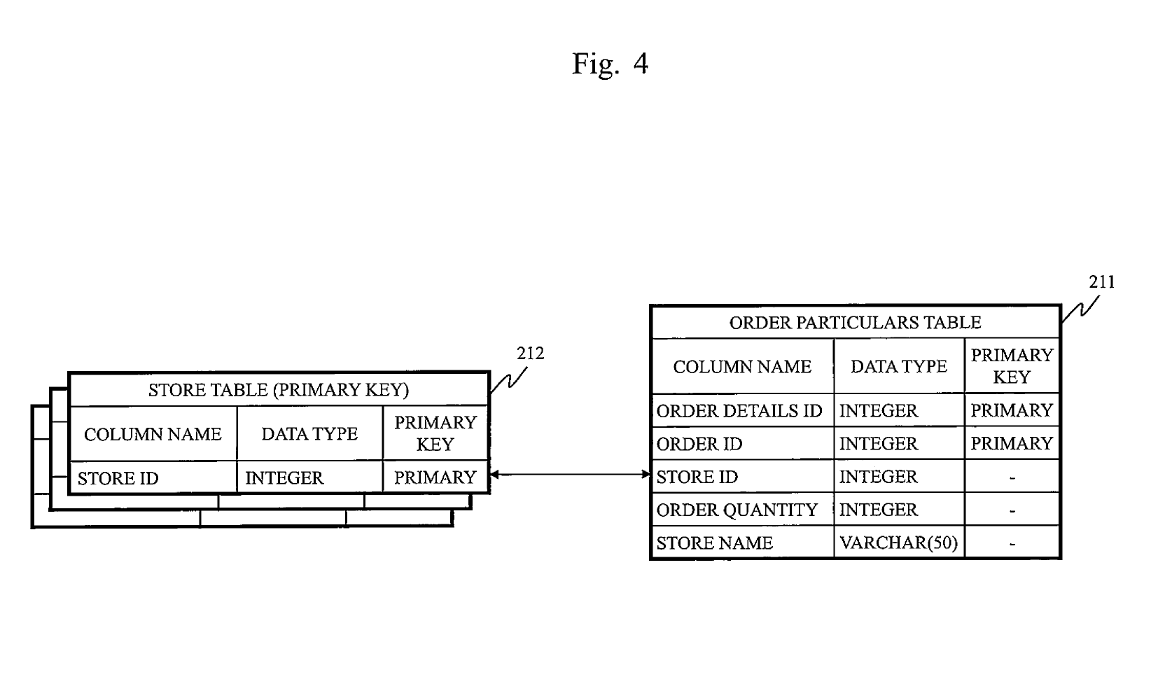

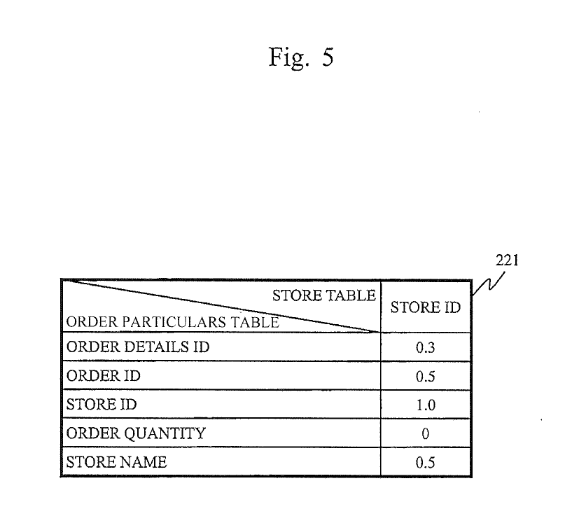

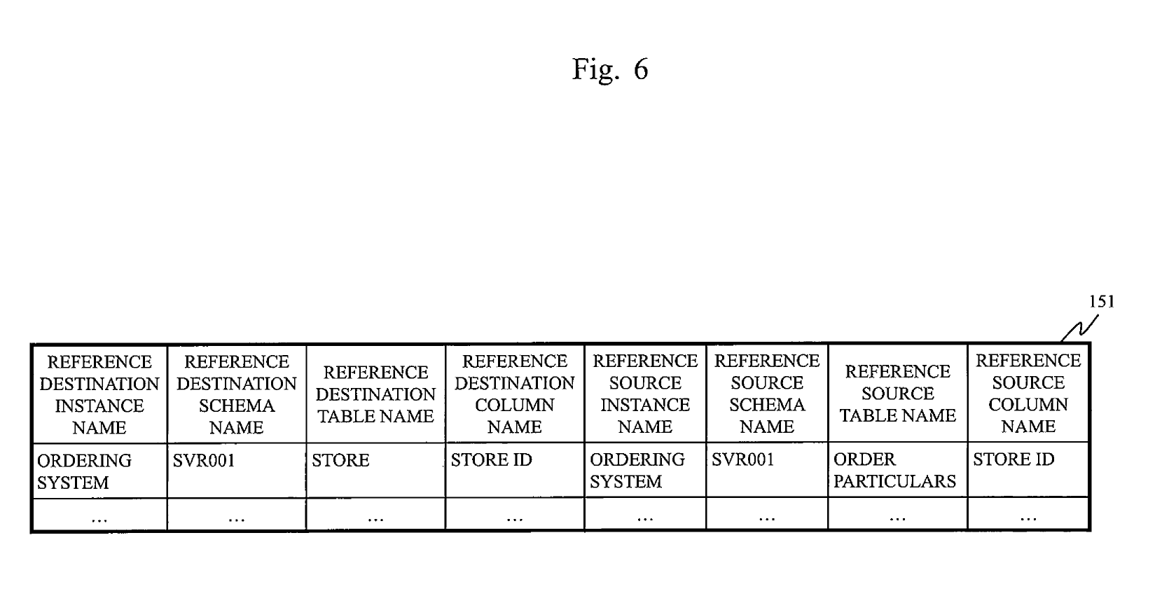

FIG. 3 is a flowchart illustrating an example of behavior of the data coordination support apparatus 100. FIG. 4 is a table illustrating an example of reference source information 211 and primary key definition information 212 which will be described later. FIG. 5 is a table illustrating an example of a result 221 of schema matching. FIG. 6 is a table illustrating an example of the reference relation information 151.

At step S11, the table selection unit 102 reads the coordination destination information 112 from the information storage unit 101. The table selection unit 102 displays a list of coordination destination tables defined by the coordination destination information 112 on a screen via the output device. The table selection unit 102 accepts, via the input device, an operation of a user looking at the list. The table selection unit 102 selects a coordination destination table according to the operation of the user. The table selection unit 102 generates the reference source information 211 that defines the coordination destination table selected in the same format as the table definition information 202.

For example, the table selection unit 102, with respect to an “Order Particulars Table” in the “SVR001” of the “Ordering System”, generates the reference source information 211 as illustrated in FIG. 4. It is defined in the reference source information 211 that the “Order Particulars Table” in the “SVR001” of the “Ordering System” includes columns “Order Details ID”, “Order ID”, “Store ID”, “Order Quantity”, and “Store Name”, and the “Order Details ID” and “Order ID” are designated as the primary key.

The table selection unit 102 delivers the reference source information 211 to the table extraction unit 104.

At step S12, the column identification unit 103 reads the coordination source information 111 from the information storage unit 101. The column identification unit 103 refers to the table definition information 202 included in the coordination source information 111 for each coordination source table defined in the table location information 201 included in the coordination source information 111. The column identification unit 103 identifies a column (i.e., a first column) of each coordination source table designated as the primary key, from the table definition information 202 of each coordination source table. The column identification unit 103 generates the primary key definition information 212 which is the table definition information 202 narrowed down to the information related only to the column identified.

For example, the column identification unit 103, with respect to the “Store” table in the “SVR001” of the “Ordering System”, generates the primary key definition information 212 as illustrated in FIG. 4. It is defined in the primary key definition information 212 that the “Store” table in the “SVR001” of the “Ordering System” includes a column “Store ID” as the primary key.

The column identification unit 103, with respect to each coordination source table, delivers the primary key definition information 212 to the table extraction unit 104.

The column identification unit 103 performs the same process, also with respect to the coordination destination information 112, and generates the primary key definition information 212 for each coordination destination table. The column identification unit 103, however, does not generate the primary key definition information 212 with respect to the coordination destination table selected at step S11.

The column identification unit 103, with respect to each coordination destination table, delivers the primary key definition information 212 to the table extraction unit 104.

At step S13, the table extraction unit 104, with respect to each coordination source table, sets a pair of the reference source information 211 delivered from the table selection unit 102 and the primary key definition information 212 delivered from the column identification unit 103. The table extraction unit 104, also with respect to each coordination destination table, sets a pair of the reference source information 211 delivered from the table selection unit 102 and the primary key definition information 212 delivered from the column identification unit 103.

At step S14, the table extraction unit 104 selects a pair for which the processes of steps S14 through S17 have not been executed yet, from among the pairs set at step S13. The table extraction unit 104 executes schema matching of the reference source information 211 and the primary key definition information 212 of the pair selected. For example, the table extraction unit 104 obtains the result 221 of the schema matching as illustrated in FIG. 5. In FIG. 5, the result 221 of the schema matching is in a format of a table in which a degree of similarity between a column of the primary key definition information 212 and a column of the reference source information 211 is indicated between 0 and 1.0. In the example of FIG. 5, the degree of similarity between the “Store ID” column of the primary key definition information 212 and the “Order Quantity” column of the reference source information 211 is 0. On the other hand, the degree of similarity between the “Store ID” column of the primary key definition information 212 and the “Store ID” column of the reference source information 211 is 1.0.

At step S15, the table extraction unit 104 extracts a pair of columns (i.e., the pair of the first column and the third column) with the degree of similarity higher than a preset threshold, from the result 221 of the schema matching obtained at step S14. In a case where a plurality of columns exist in the primary key definition information 212, the table extraction unit 104, with respect to all of the columns of the primary key definition information 212, is required to extract a pair of columns so that there is no duplicate column of the reference source information 211. In a case where there are two or more pairs of columns with the degree of similarity higher than the threshold for the same column of the primary key definition information 212, the table extraction unit 104 selects the pair of columns with the highest degree of similarity. In a case where there is no pair of columns with the degree of similarity higher than the threshold, the table extraction unit 104 proceeds to step S18 without extracting a pair of columns. In the example of FIG. 5, assuming the threshold is 0.8, the table extraction unit 104 is to extract the pair of the “Store ID” column of the primary key definition information 212 and the “Store ID” column of the reference source information 211.

In a case where there is a pair of columns extracted at step S15, the table extraction unit 104, at step S16, generates the reference relation information 151 indicating the pair of columns extracted. The table extraction unit 104 saves the reference relation information 151 in the information accumulation unit 105.

For example, the table extraction unit 104 generates the reference relation information 151 as illustrated in FIG. 6. Information of a reference destination instance name, a reference destination schema name, a reference destination table name, a reference destination column name, a reference source instance name, a reference source schema name, a reference source table name, and a reference source column name is included in the reference relation information 151. It is defined in the reference relation information 151 that there is a reference relation between the “Store” table in the “SVR001” of the “Ordering System”, and the “Order Particulars” table in the “SVR001” of the “Ordering System”. It is also defined that the “Store ID” column of the “Store” table is a reference destination, and the “Store ID” column of the “Order Particulars” table is a reference source (i.e., a foreign key).

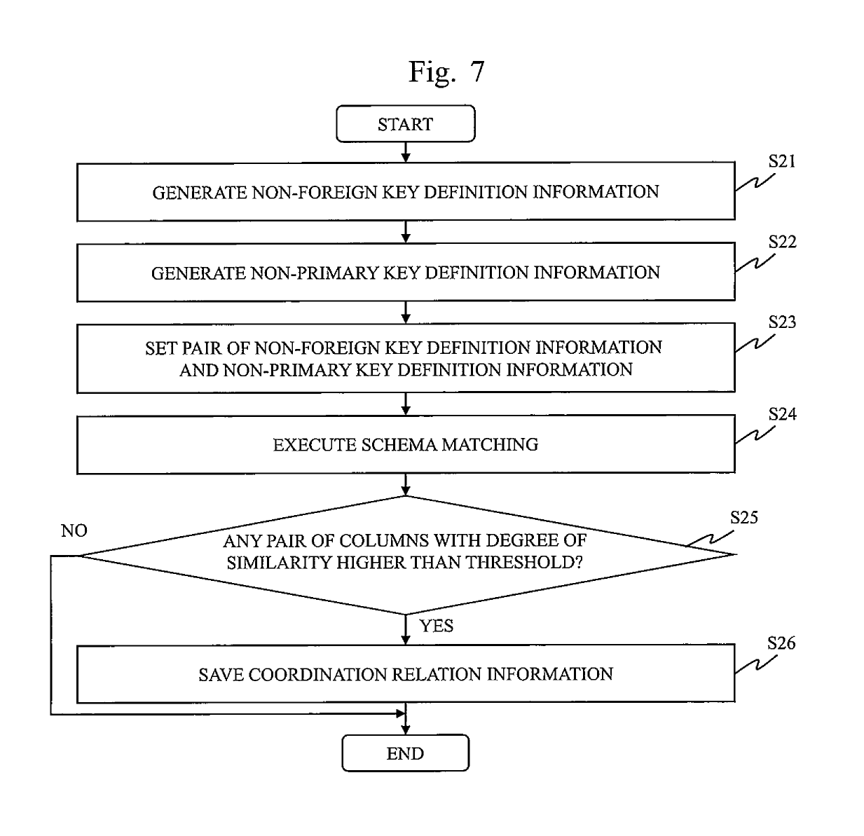

At step S17, the data coordination support apparatus 100 performs the behavior illustrated in FIG. 7.

At step S18, the table extraction unit 104 judges whether or not there is a pair for which the processes of steps S14 through S17 have not been executed yet, among the pairs set at step S13. In a case where there is such a pair, the table extraction unit 104 returns to step S14. In a case where there is no such pair, the table extraction unit 104 finishes the processing.

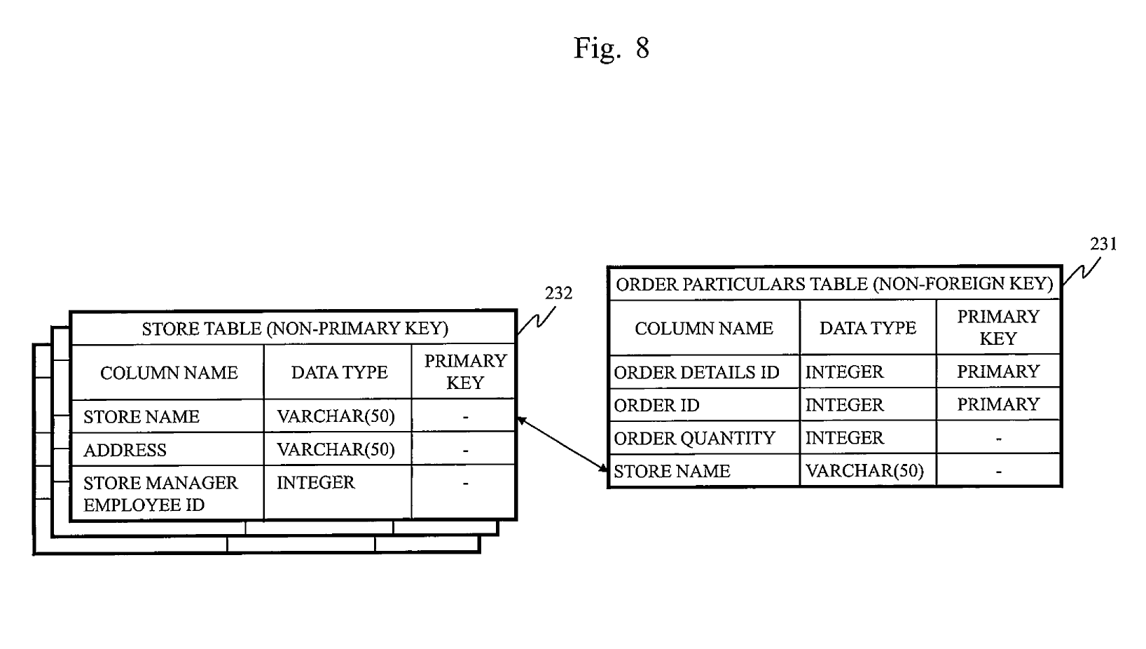

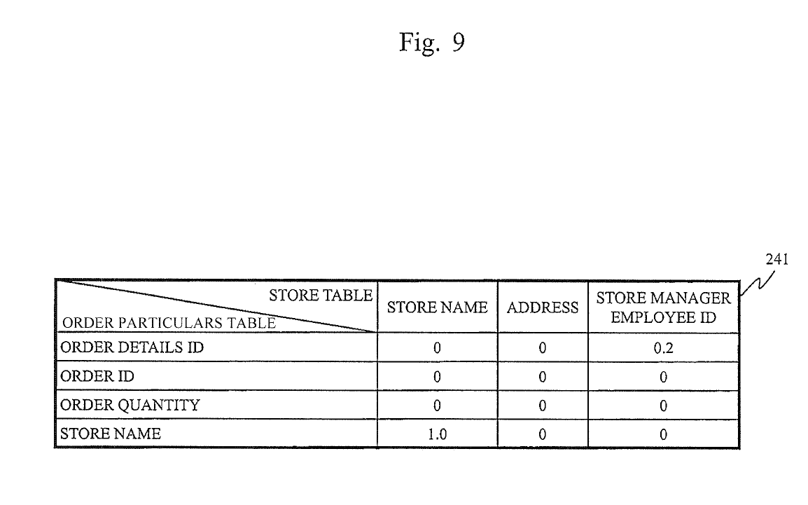

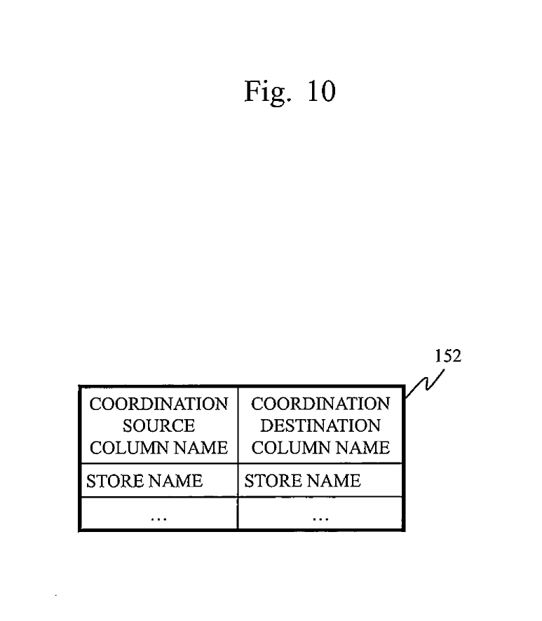

FIG. 7 is a flowchart illustrating an example of behavior of the data coordination support apparatus 100 at step S17. FIG. 8 is a table illustrating an example of non-foreign key definition information 231 and non-primary key definition information 232 which will be described later. FIG. 9 is a table illustrating an example of a result 241 of schema matching. FIG. 10 is a table illustrating an example of the coordination relation information 152.

At step S21, the table selection unit 102 reads the reference relation information 151 from the information accumulation unit 105. The table selection unit 102 generates the non-foreign key definition information 231 which is the reference source information 211 generated at step S11 and narrowed down to the information related only to the column(s) other than the reference source column defined in the reference relation information 151.

For example, the table selection unit 102, with respect to the “Order Particulars Table” in the “SVR001” of the “Ordering System”, generates the non-foreign key definition information 231 as illustrated in FIG. 8. It is defined in the non-foreign key definition information 231 that the “Order Particulars Table” in the “SVR001” of the “Ordering System” includes columns “Order Details ID”, “Order ID”, “Order Quantity”, and “Store Name” as non-foreign keys, and the “Order Details ID” and “Order ID” are designated as the primary key.

The table selection unit 102 delivers the non-foreign key definition information 231 to the table extraction unit 104.

At step S22, the column identification unit 103 reads the reference relation information 151 from the information accumulation unit 105. The column identification unit 103 refers to the table definition information 202 included in the coordination source information 111 or in the coordination destination information 112 read at step S12 with respect to the reference destination table defined in the reference relation information 151. The column identification unit 103 identifies a column (i.e., a second column) of the reference destination table not designated as the primary key, from the table definition information 202 of the reference destination table. The column identification unit 103 generates the non-primary key definition information 232 which is the table definition information 202 narrowed down to the information related only to the column identified.

For example, the column identification unit 103, with respect to the “Store” table in the “SVR001” of the “Ordering System”, generates the non-primary key definition information 232 as illustrated in FIG. 8. It is defined in the non-primary key definition information 232 that the “Store” table in the “SVR001” of the “Ordering System” includes columns “Store Name”, “Address”, and “Store Manager Employee ID” as non-primary keys.

The column identification unit 103 delivers the non-primary key definition information 232 to the table extraction unit 104.

At step S23, the table extraction unit 104 sets a pair of the non-foreign key definition information 231 delivered from the table selection unit 102 and the non-primary key definition information 232 delivered from the column identification unit 103.

At step S24, the table extraction unit 104 executes schema matching of the non-foreign key definition information 231 and the non-primary key definition information 232 of the pair set at step S23. For example, the table extraction unit 104 obtains the result 241 of the schema matching as illustrated in FIG. 9. In FIG. 9, the result 241 of the schema matching, in the same manner as the example of FIG. 5, is in a format of a table in which a degree of similarity between a column of the non-primary key definition information 232 and a column of the non-foreign key definition information 231 is indicated between 0 and 1.0. In the example of FIG. 9, the degree of similarity between the “Store Name” column of the non-primary key definition information 232 and the “Order Details ID” column of the non-foreign key definition information 231 is 0. On the other hand, the degree of similarity between the “Store Name” column of the non-primary key definition information 232 and the “Store Name” column of the non-foreign key definition information 231 is 1.0.

At step S25, the table extraction unit 104 extracts a pair of columns (i.e., the pair of the second column and the fourth column) with the degree of similarity higher than a preset threshold, from the result 241 of the schema matching obtained at step S24. In a case where a plurality of columns exist in the non-primary key definition information 232, the table extraction unit 104, is required to extract a pair of columns so that there is no duplicate column of the non-foreign key definition information 231. In a case where there are two or more pairs of columns with the degree of similarity higher than the threshold for the same column of the non-primary key definition information 232, the table extraction unit 104 selects the pair of columns with the highest degree of similarity. In a case where there is no pair of columns with the degree of similarity higher than the threshold, the table extraction unit 104 finishes the processing without extracting a pair of columns. In the example of FIG. 9, assuming the threshold is 0.8, the table extraction unit 104 is to extract the pair of the “Store Name” column of the non-primary key definition information 232 and the “Store Name” column of the non-foreign key definition information 231. The table extraction unit 104 does not extract a pair of columns with respect to the “Address” column and the “Store Manager Employee ID” column of the non-primary key definition information 232.

In a case where there is a pair of columns extracted at step S25, the table extraction unit 104, at step S26, generates the coordination relation information 152 indicating the pair of columns extracted. The table extraction unit 104 saves the coordination relation information 152 in the information accumulation unit 105.

For example, the table extraction unit 104 generates the coordination relation information 152 as illustrated in FIG. 10. Information of a reference source column name and a reference destination column name is included in the coordination relation information 152. The coordination relation information 152 is synthesized with the reference relation information 151 illustrated in FIG. 6. That is, information of the reference destination instance name, the reference destination schema name, the reference destination table name, the reference destination column name, the coordination source column name, the reference source instance name, the reference source schema name, the reference source table name, the reference source column name, and the coordination destination column name is included in the synthesized information of the reference relation information 151 and the coordination relation information 152. It is defined in the synthesized information that the “Store Name” column of the “Store” table in the “SVR001” of the “Ordering System” is the coordination source and that the “Store Name” column of the “Order Particulars” table in the “SVR001” of the “Ordering System” is the coordination destination. In a case where there are two or more pairs of the coordination source and the coordination destination, the coordination source column names and the coordination destination column names are stored in the same order. For example, assume that the “Store Name” column of the “Store” table and the “Store Name” column of the “Order Particulars” table are a pair, and the “Address” column of the “Store” table and an “Address” column of the “Order Particulars” table are a pair. If the coordination source column names are stored in the order of “Store Name” and then “Address”, the coordination destination column names are also stored in the order of “Store Name” and then “Address”.

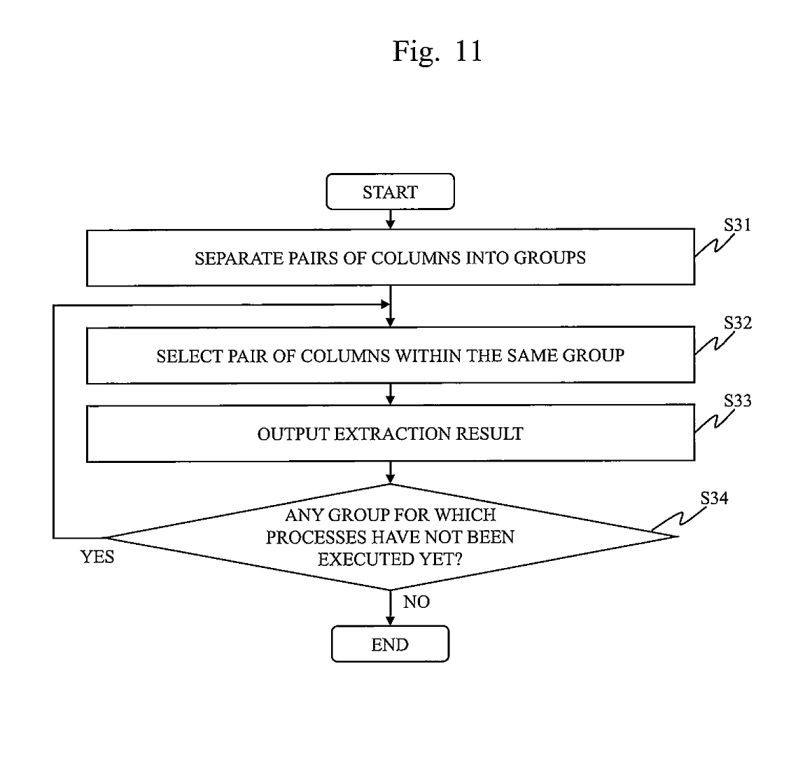

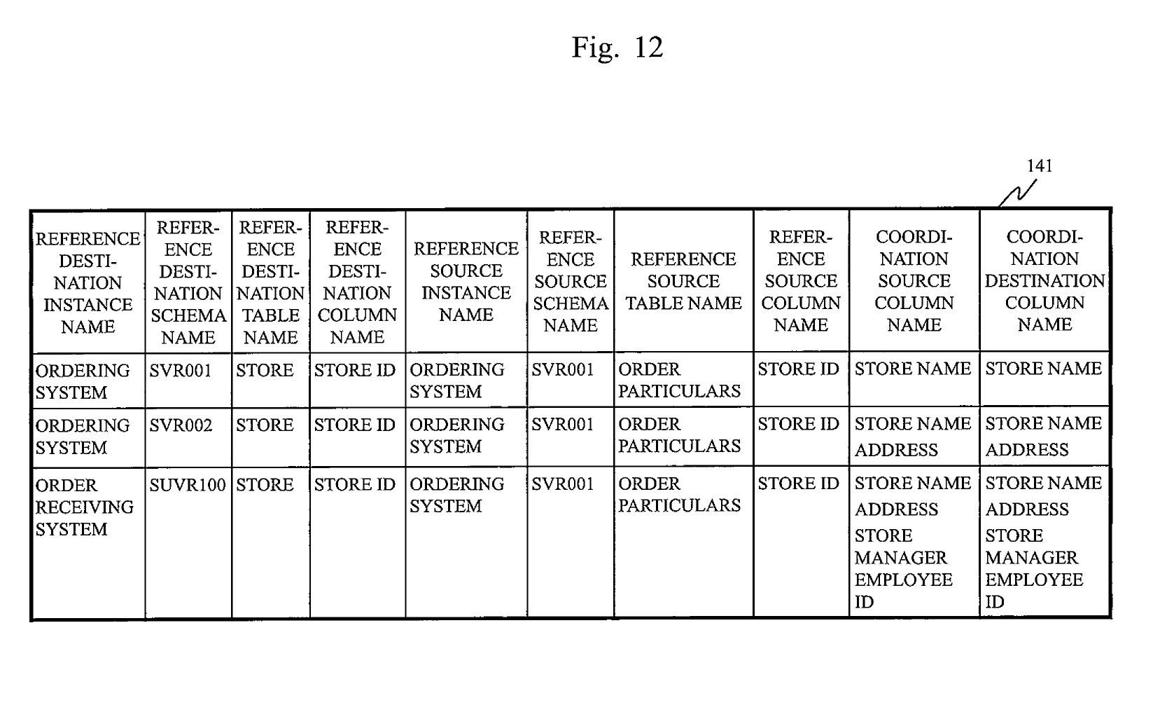

FIG. 11 is a flowchart illustrating an example of behavior of the data coordination support apparatus 100 after the behavior illustrated in FIG. 3. FIG. 12 is a table illustrating an example of the extraction result 141.

At step S31, the table extraction unit 104 reads the reference relation information 151 and the coordination relation information 152 from the information accumulation unit 105. The table extraction unit 104 separates the pairs of the reference destination column and the reference source column (i.e., the first column and the third column) indicated by the reference relation information 151 and the coordination relation information 152, into groups depending on to which schema the reference destination table and the reference source table belong. Specifically, the table extraction unit 104 classifies the pairs of the reference destination column and the reference source column into three groups: a group with respect to which the reference destination table and the reference source table belong to the same schema, a group with respect to which the reference destination table and the reference source table belong to a different schema of the same instance, and a group with respect to which the reference destination table and the reference source table each belongs to a schema of a different instance.

At step S32, the table extraction unit 104 selects a group for which the processes of steps S32 and S33 have not been executed yet, from among the three groups described above. The table extraction unit 104 extracts a pair that corresponds to the largest number of pairs of the coordination source column and the coordination destination column, from among the pairs classified into the selected group at step S31.

At step S33, the table extraction unit 104 outputs the extraction result 141 that indicates the pair of the reference destination column and the reference source column extracted at step 32, in the same format as the synthesized information of the reference relation information 151 and the coordination relation information 152.

For example, the table extraction unit 104 outputs the extraction result 141 as illustrated in FIG. 12. It is indicated in the extraction result 141 that there is a reference relation between the “Store” table in the “SVR001” of the “Ordering System” and the “Order Particulars” table in the “SVR001” of the “Ordering System”. It is also indicated that the “Store ID” column of the “Store” table is the reference destination, that the “Store Name” is the coordination source, that the “Store ID” column of the “Order Particulars” table is the reference source (i.e., the foreign key), and that the “Store Name” is the coordination destination.

At step S34, the table extraction unit 104 judges whether or not there is a group for which the processes of steps S32 and S33 have not been executed yet, among the three groups described above. In a case where there is such a group, the table extraction unit 104 returns to step S32. In a case where there is no such group, the table extraction unit 104 finishes the processing.

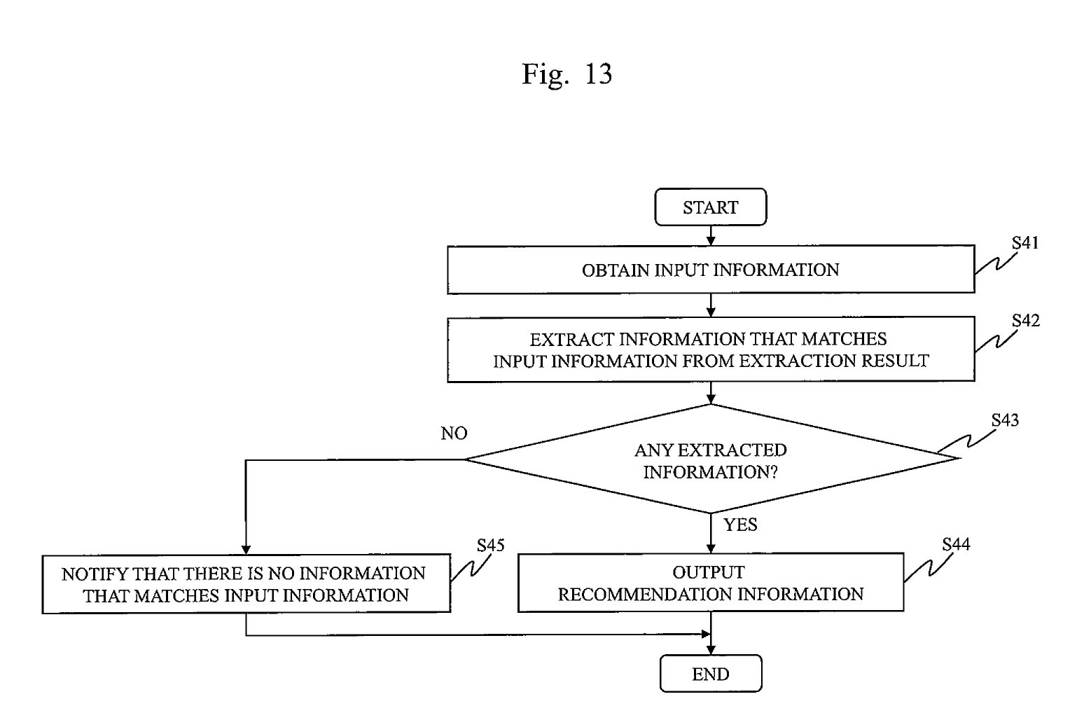

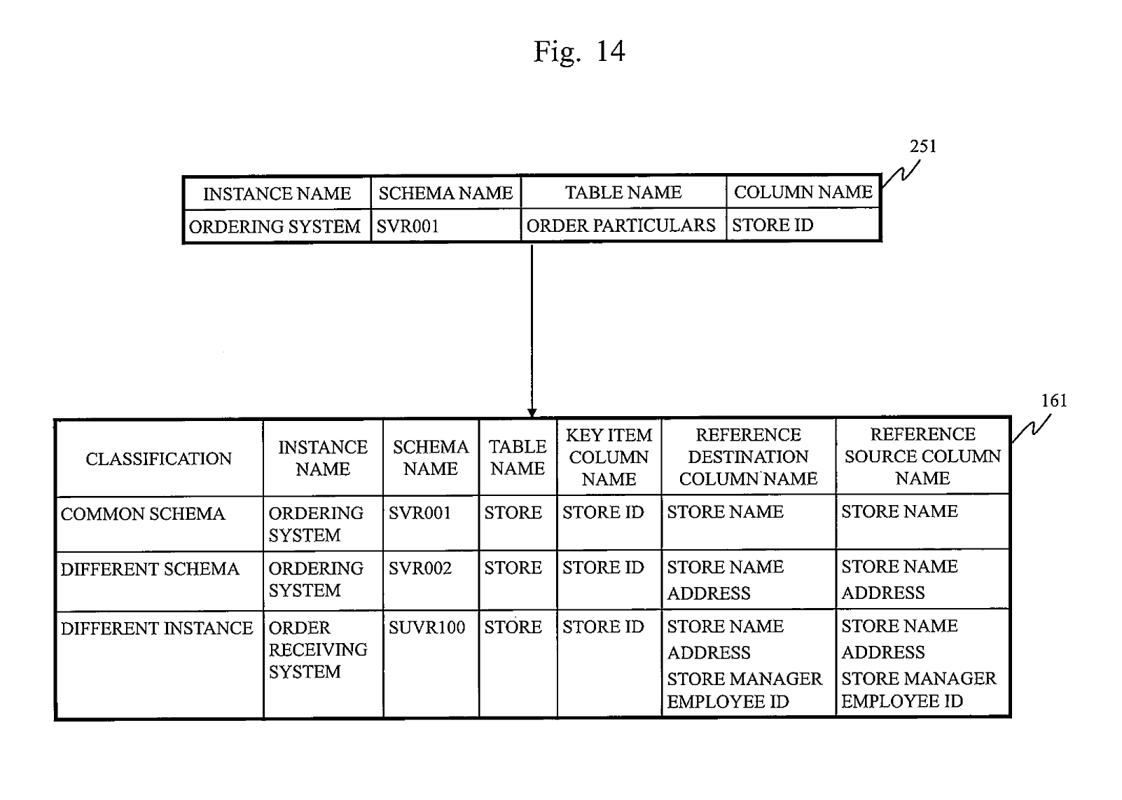

FIG. 13 is a flowchart illustrating an example of behavior of the data coordination support apparatus 100 after the behavior illustrated in FIG. 11. FIG. 14 is a table illustrating an example of input information 251 and recommendation information 161 which will be described later.

At step 41, the information output unit 106 obtains the input information 251 inputted by the user to search for a reference destination, via the input device.

For example, the information output unit 106 obtains the input information 251 as illustrated in FIG. 14. It is indicated in the input information 251 that the user wants to search for a reference destination corresponding to the “Store ID” column of the “Order Particulars” table in the “SVR001” of the “Ordering System”. In a case where a column name is omitted, the information output unit 106 may interpret it as meaning that the user wants to search for a reference destination corresponding to any of the columns in the “Order Particulars” table.

At step S42, the information output unit 106 refers to the extraction result 141 outputted from the table extraction unit 104 at step S33. The information output unit 106 extracts, from the extraction result 141, information that matches the input information 251 obtained at step 541. Specifically, the information output unit 106 extracts a combination that matches a combination of an instance, a schema, a table, and a column indicated in the input information 251, from among a combination of a reference source instance, a reference source schema, a reference source table, and a reference source column indicated in the extraction result 141.

At step S43, the information output unit 106 judges whether or not there is information extracted at step S42. In a case where there is extracted information, the information output unit 106 proceeds to step S44. In a case where there is no extracted information, the information output unit 106 proceeds to step S45.

At step S44, the information output unit 106 generates the recommendation information 161 that recommends a reference destination corresponding to the input information 251 with respect to each of the three groups described above, based on the information extracted at step S42. The information output unit 106 outputs the recommendation information 161 via the output device, and finishes the processing.

For example, the information output unit 106 displays the recommendation information 161 as illustrated in FIG. 14 on the screen. It is indicated in the recommendation information 161 that, with respect to a group for which the reference destination table and the reference source table belong to the same schema (i.e., “common schema”), the “Store ID” column of the “Store” table in the “SVR001” of the “Ordering System” is recommended as the reference destination. In addition, it is indicated that data to be contained in the “Store Name” column of the “Order Particulars” table indicated in the input information 251 should be extracted from the “Store Name” column of the “Store” table in the “SVR001” of the “Ordering System”.

At step S45, the information output unit 106 outputs, via the output device, information notifying that there is no reference destination corresponding to the input information 251, and finishes the processing.

In the present embodiment, a reference relation between tables and a column which is to be a foreign key can be identified only from definition information of a database by the behavior described above. Furthermore, common columns between tables having the reference relation can be identified, and the most appropriate table (i.e., a table having the largest number of columns that can be used in the data coordination) for use in the data coordination can be extracted. In other words, according to the present embodiment, it is possible to efficiently detect between which table and a table being a coordination destination there is the reference relation, in the data coordination. Furthermore, it is possible to efficiently detect from a column of which table the data to be contained in a column of a table being a coordination destination should be extracted.

As described above, in the present embodiment, the table extraction unit 104, with respect to a table in which two or more second columns are identified by the column identification unit 103, includes in the extraction result 141, only such a table that the fourth column exists, in the coordination destination table selected by the table selection unit 102, individually for the largest number of the second columns. In a variation of the present embodiment, the table extraction unit 104, with respect to a table in which two or more second columns are identified by the column identification unit 103, may also include in the extraction result 141, such a table that the fourth column exists, in the coordination destination table selected by the table selection unit 102, individually for the second largest number of the second columns. Alternatively, not only the “second”, but also the “top n” may be included. An arbitrary number larger than two can be set as “n”.

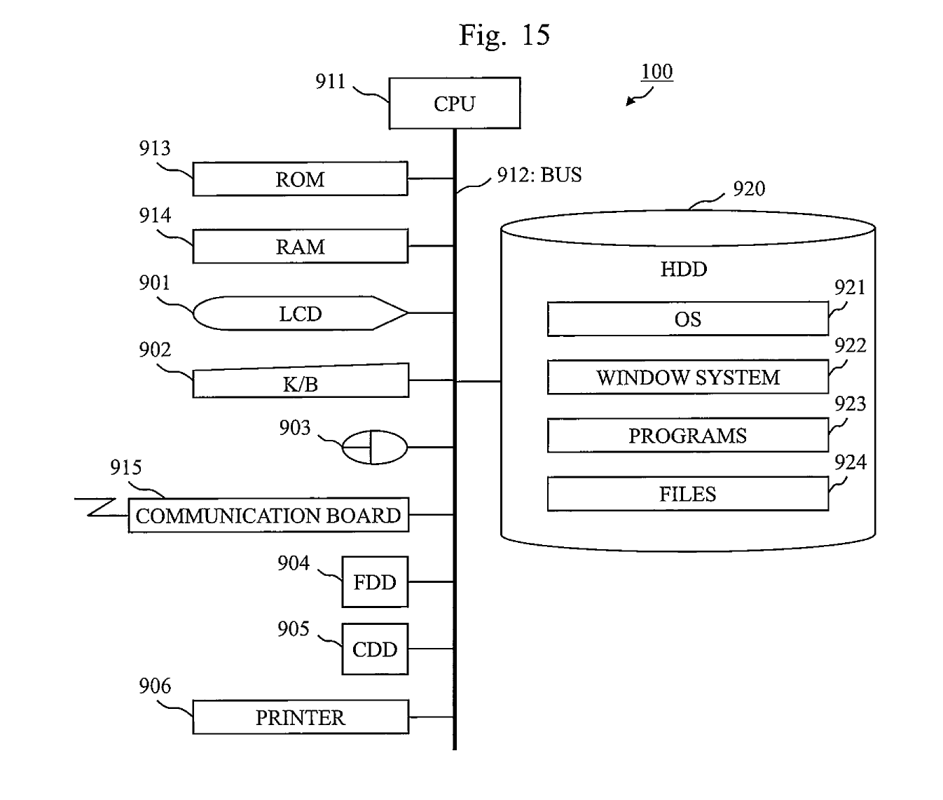

FIG. 15 is a diagram illustrating an example of a hardware configuration of the data coordination support apparatus 100 according to the first embodiment.

Referring to FIG. 15, the data coordination support apparatus 100 is a computer and includes hardware devices such as an LCD 901 (Liquid Crystal Display), a keyboard 902 (K/B), a mouse 903, an FDD 904 (Flexible Disk Drive), a CDD 905 (Compact Disc Drive), and a printer 906. These hardware devices are connected to each other via cables or signal lines. In place of the LCD 901, a CRT (Cathode Ray Tube) or another display device may be employed. hi place of the mouse 903, a touch panel, a touch pad, a track ball, a pen tablet, or another pointing device may be employed.

The data coordination support apparatus 100 includes a CPU 911 (Central Processing Unit) which executes programs. The CPU 911 is an example of the processing device. The CPU 911 is connected to a ROM 913 (Read Only Memory), a RAM 914 (Random Access Memory), a communication board 915, the LCD 901, the keyboard 902, the mouse 903, the FDD 904, the CDD 905, the printer 906, and an HDD 920 (Hard Disk Drive) via a bus 912, and controls these hardware devices. In place of the HDD 920, an SSD (Solid State Drive), a flash memory, an optical disc device, a memory card reader/writer, or another recording medium may be employed.

The RAM 914 is an example of a volatile memory. The ROM 913, the FDD 904, the CDD 905, and the HDD 920 are examples of a nonvolatile memory. These are examples of the storage device. The communication board 915, the keyboard 902, the mouse 903, the FDD 904, and the CDD 905 are examples of the input device. Also, the communication board 915, the LCD 901, and the printer 906 are examples of the output device.

The communication board 915 is connected to a LAN (Local Area Network) or the like. The communication board 915 may be connected not only to the LAN, but also to a WAN (Wide Area Network) such as an IP-VPN (Internet Protocol Virtual Private Network), a wide area LAN, or an ATM (Asynchronous Transfer Mode) network, or to the Internet. The LAN, the WAN, and the Internet are examples of a network.

The HDD 920 stores an operating system 921 (OS), a window system 922, programs 923, and files 924. Each program of the programs 923 is executed by the CPU 911, the operating system 921, and the window system 922. The programs 923 include programs that execute functions described as “units” in the description of the embodiment of the present invention. The program is read and executed by the CPU 911. The files 924 include data, information, signal values, variable values, and parameters described as “data”, “information”, “ID (identifier)”, “flag”, or “result” in the description of the embodiment of the present invention, as the items of a “file”, “database”, and “table”. The “file”, “database”, and “table” are stored in a recording medium such as the RAM 914 or the HDD 920. The data, information, signal values, variable values, and parameters stored in the recording medium such as the RAM 914 or the HDD 920 are read into a main memory or a cache memory by the CPU 911 via a read/write circuit, and are used for the processing (behavior) of the CPU 911 such as extraction, search, reference, comparison, computation, calculation, control, output, print, and display. The data, information, signal values, variable values, and parameters are temporarily stored in the main memory, the cache memory, or a buffer memory during the processing of the CPU 911 such as extraction, search, reference, comparison, computation, calculation, control, output, print, and display.

The arrows in the block diagrams and the flowcharts used in the description of the embodiment of the present invention primarily denote inputs/outputs of data and signals. The data and signals are recorded in a memory such as the RAM 914, a flexible disk (FD) of the FDD 904, a compact disc (CD) of the CDD 905, a magnetic disk of the HDD 920, an optical disc, a DVD (Digital Versatile Disc), or other types of recording medium. The data and signals are transmitted by the bus 912, a signal line, a cable, or other types of transmission medium.

What is described as a “unit” in the description of the embodiment of the present invention may be a “circuit”, a “device”, an “appliance”, or a “step”, a “procedure”, or a “process”. Namely, what is described as a “unit” may be realized by firmware stored in the ROM 913. Alternatively, what is described as a “unit” may be realized solely by software, or solely by hardware such as an element, a device, a substrate, or a wiring line. Alternatively, what is described as a “unit” may be realized by a combination of software and hardware, or by a combination of software, hardware, and firmware. The firmware and software are stored, as programs, in a recording medium such as a flexible disk, a compact disc, a magnetic disk, an optical disc, or a DVD. The programs are read by the CPU 911 and are executed by the CPU 911. That is, each program causes the computer to function as a “unit” described in the description of the embodiment of the present invention. Alternatively, each program causes the computer to execute a procedure or method of a “unit” described in the description of the embodiment of the present invention.

The embodiment of the present invention has been described above. The present invention is not limited to this embodiment, and various modifications are possible as necessary.

### REFERENCE SIGNS LIST

100: data coordination support apparatus; 101: information storage unit; 102: table selection unit; 103: column identification unit; 104: table extraction unit; 105:

information accumulation unit; 106: information output unit; 111: coordination source information; 112: coordination destination information; 141: extraction result; 151: reference relation information; 152: coordination relation information; 161: recommendation information; 201: table location information; 202: table definition information; 211: reference source information; 212: primary key definition information; 221: result; 231: non-foreign key definition information; 232: non-primary key definition information; 241: result; 251: input information; 901: LCD; 902: keyboard; 903: mouse; 904: FDD; 905: CDD; 906: printer; 911: CPU; 912: bus; 913: ROM; 914: RAM; 915: communication board; 920: HDD; 921: operating system; 922: window system; 923: programs; 924: files

1. A data coordination support apparatus that supports data coordination of a database including a plurality of tables, the data coordination support apparatus comprising:
an information storage unit to store primary key information indicating whether or not each of a plurality of columns included in each of the plurality of tables is designated as a primary key, and attribute information indicating an attribute of data contained in each of the plurality of columns included in each of the plurality of tables;
a table selection unit to select a table being a coordination destination of the data coordination, from among the plurality of tables;
a column identification unit to identify, with respect to each table among the plurality of tables other than the table selected by the table selection unit, a first column designated as the primary key and a second column not designated as the primary key, from a plurality of columns included in a table, based on the primary key information stored in the information storage unit;
a table extraction unit to extract such a table that a third column similar to the first column identified by the column identification unit is included in the table selected by the table selection unit, and a fourth column similar to the second column identified by the column identification unit is included in the table selected by the table selection unit, from tables among the plurality of tables other than the table selected by the table selection unit, based on the attribute information stored in the information storage unit; and
an information output unit to output recommendation information that recommends using a combination of the table selected by the table selection unit and the table extracted by the table extraction unit, in the data coordination, wherein
the table extraction unit, with respect to a table in which two or more second columns are identified by the column identification unit, extracts such a table that the fourth column exists, in the table selected by the table selection unit, individually for a largest number of the second columns.

2. The data coordination support apparatus according to claim 1, wherein
the table extraction unit, with respect to a table in which two or more first columns are identified by the column identification unit, extracts such a table that the third column exists, in the table selected by the table selection unit, individually for all of the first columns.

3. (canceled)

4. The data coordination support apparatus according to claim 1, wherein
the table extraction unit extracts at least two types of tables out of three types of tables, the three types of tables being a table that belongs to a same schema as the table selected by the table selection unit, a table that belongs to a different schema of a same instance as the table selected by the table selection unit, and a table that belongs to a schema of a different instance than the table selected by the table selection unit, and
the information output unit outputs, as the recommendation information, information that recommends using the combination of the table selected by the table selection unit and the table extracted by the table extraction unit, in the data coordination, for each type of the table extracted by the table extraction unit.

5. A data coordination support method that supports data coordination of a database including a plurality of tables, the data coordination support method comprising:
by use of a computer which includes an information storage unit that stores primary key information indicating whether or not each of a plurality of columns included in each of the plurality of tables is designated as a primary key, and attribute information indicating an attribute of data contained in each of the plurality of columns included in each of the plurality of tables, selecting a table being a coordination destination of the data coordination, from among the plurality of tables;
by use of the computer, identifying, with respect to each table among the plurality of tables other than the table selected by the selecting, a first column designated as the primary key and a second column not designated as the primary key, from a plurality of columns included in a table, based on the primary key information stored in the information storage unit;
by use of the computer, extracting such a table that a third column similar to the first column identified by the identifying is included in the table selected by the selecting, and a fourth column similar to the second column identified by the identifying is included in the table selected by the selecting, from tables among the plurality of tables other than the table selected by the selecting, based on the attribute information stored in the information storage unit; and
by use of the computer, outputting recommendation information that recommends using a combination of the table selected by the selecting and the table extracted by the extracting, in the data coordination, wherein
the extracting, with respect to a table in which two or more second columns are identified by the identifying, extracts such a table that the fourth column exists, in the table selected by the selecting, individually for a largest number of the second columns.
